(19) United States
(12) Patent Application Publication
(10) Pub. No.: US 2007/0261250 A1
(43) Pub. Date: Nov. 15, 2007

(54) Combination wire stamper, stripper and labeler

(76) Inventor: Herbert Bosch, Fort Myers, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/430,343

(22) Filed: May 9, 2006

(51) Int. Cl. H02G 1/12; B44B 5/00

(52) U.S. Cl. 30/90.1; 101/26

(57) ABSTRACT

A combination wire cutter, stripper comprising a pair of handles joined at a pivot point, each handle terminating in semi cylindrical housing disposed distally from the pivot point, said semi cylindrical housings are made to mate and form a cylindrical housing when the handles are compressed. The interior of the housings of have mating central cutting blades which cut a wire when the handles are compressed; mating stripping blades disposed on opposite sides of the cutting blades to splice a wire on opposing sides of the central cutting blade when the handles are depressed so as to remove its outer sheath; and mating number stampers disposed on the side of the stripping blade opposite to the central blade for applying a number when the wire and when the handles are compressed.

### FIELD OF THE INVENTION

The present invention is directed to the field of electrical wire cable cutters. Specifically, the present invention is directed to a combination wire cutter, labeler, and stripper.

### BACKGROUND OF THE INVENTION

Working with electricity and electrical wiring can be a difficult and time-consuming task. In particular, it is often difficult to gather and switch tools while working. Each new or re-routed wire must be cut and stripped before it is attached to an electrical source. Because of the frequent need to connect proper wires over distances, labeling of wiring is important. Labeling of wiring is a particularly difficult and time consuming task.

Performing this task, has until now, required several different tools. The electrician or his helper would be required to carry all of the necessary tools or to stop the process to obtain the necessary tools.

The patent literature is replete with devices for cutting, and/or stripping and splicing cables. For example, U.S. Pat. No. 5,019,674 discloses a wire splicing device for connecting electrical conductors and includes a flexible sleeve formed of a non-conductive material and having a pair of openings therein. A pair of elongate arms are integrally connected with the exterior surface of the sleeve adjacent one end thereof and extend longitudinally towards the other end of the sleeve. The free end of each arm has a pressure element extending therefrom towards one of the openings in the sleeve. An elongate rigid electrically conductive splicing member is positioned within the sleeve and includes end elements, each having penetrating teeth struck there from. The teeth on the splicing member penetrate the insulation on the conductors to thereby electrically connect the conductors together and lock the conductors in the sleeve.

U.S. Pat. No. 5,689,874 discloses a wire cutting and stripping mechanism (22) for use with a wire processing machine (10) is disclosed. The mechanism includes a pair of cutting and stripping blade (180, 182, 184) tool holders (60, 62) which are slidingly coupled to the frame (16) of the machine. The tool holders are arranged to move toward a wire (12) to be processed in two discrete amounts of movement which are separable by a pause in movement. A pair of cylinders (130, 132) are interconnected to effect these two discrete movements. During the first movement the wire 12 is severed, followed by a pause in movement while the cut wire is repositioned axially with respect to the stripping blades (182, 184). The second movement is then initiated to sever the insulation, the stripping blades (182, 184) being held in position while the wire is withdrawn to strip off the slug (196) of cut insulation.

U.S. Pat. No. 5,515,602 discloses a method of processing a wire to cut the wire into sections and to strip sheathing from the wire to expose wire ends at opposite ends of the sections, and by operation of wire feed means and cutter means, the steps that include operating the feed means and cutter means to displace the wire endwise along an axis to a first position; sever the wire thereby to form wire forward and rearward sections, the forward section having a rearward end portion; and, the rearward section having a forward end portion, and; stripping sheathing from the forward section rearward portion and from the rearward section forward portion thereby to expose wire ends at the portions; the cutter means including three blade pairs, each pair including two blades located at opposite sides of the axis, both blades of one pair being displaced toward the wire to sever the wire, and both blades of the remaining two pairs being displaced toward the wire sections to strip sheathing from the rearward and forward portions during controlled endwise displacement of the sections. A sheathing slug or slugs may alternatively be relatively displaced along the wire section or sections to protectively overhang an end or ends of wire metal core, the slug or slugs not then be completely stripped from the section or sections.

U.S. Pat. No. 6,662,450 discloses a tool manipulating device including a combination of depth setting, length adjusting and work piece clamp members provided on a longitudinal hand-held handle. The depth setting member has a blade assembly that extends perpendicular to the hand-held handle. The blade assembly is capable of rotating onto itself after penetrating into a work piece to be stripped from its jacket at a predetermined depth to produce a ring cut and an axial cut of the work piece upon sequentially rotating and axially pulling the cable relative to the handle.

U.S. Pat. No. 5,243,882 discloses a device for the mechanical stripping of at least two layers of electrical or optical cables having a stop for a fed-in conductor. The conductor is fixed in position by clamping jaws, whereupon its insulation can be severed by at least one rotating stripping blade. Disposed immediately next to each blade is a centering jaw, which centers the conductor. The jaw is radially movable relative to the blade so as to permit the penetration of the blade into the layer of insulation. The blades and the centering jaws are positioned axially and the desired cutting depth of each of at least two stripping operations is adjusted by spindles, each of which is operated by a motor which is controlled by a digital controller.

While there have been a number of devices for cutting and/or stripping wires, there has been no system which provides cutting, stripping and labeling.

It is an object of the present invention to provide a cutter and stripper with labeling system.

It is another object of the present invention to provide a cutter and stripper with a labeling system which completes the process in one step.

It is a further object of the present invention to provide a cutter, striper and labeler which can be hand held or powered.

These and other objects of the present invention will become apparent from the detailed description which follows.

### SUMMARY OF THE INVENTION

The invention is a timesaving device for providing electricians with a variety of necessary tools in one efficient and simply designed hand tool. This invention cuts, strips, and labels wires easily and efficiently in seconds. This tool will replace a number of other tools used when working with electrical wiring.

It is an aspect of the present invention to provide a device for cutting, stripping and labeling comprising of a pair of handles joined at a pivot point, each handle terminating in a housing portion disposed distally from the pivot point; said semi cylindrical housing portions being configured to mate and form a full housing when the handles are compressed. The interior of each housing further comprises mateable central cutting blades which converge to cut a wire when the handles are compressed; mateable splicing blades disposed on opposite sides of the cutting blades which converge to splice the sheath of a wire when the handles are depressed, so as to remove outer sheath; and mateable number stampers disposed on the side of the splicing blade opposite to the central blade, for applying a number when the wire and when the handles are compressed.

In another embodiment, the present invention is a combination wire cutter, stripper comprising a pair of handles joined at a pivot point, each handle terminating in semi cylindrical housing disposed distally from the pivot point; said semi cylindrical housings are made to mate and form a cylindrical housing when the handles are compressed, the interior of the housings comprising a central aperture to hold a wire, mating central cutting blades which cut a wire when the handles are compressed; mating stripping blades disposed on opposite sides of the cutting blades to strip a wire on opposing sides of the central cutting blade when the handles are depressed so as to remove its outer sheath; and mating number stampers disposed on the side of the stripping blade opposite to the central blade for applying a number when the wire and when the handles are compressed.

In a further embodiment, the present invention is a combination wire cutter, stripper and labeler comprising a pair of handles joined at a pivot point, each handle terminating in semi cylindrical housing disposed distally from the pivot point, said semi cylindrical housings made to mate to form a cylindrical housing when the handles are compressed the interior of the housings having; replaceable mating central cutting blades which cut a wire when the handles are compressed; replaceable mating stripping blades disposed on opposite sides of the cutting blades to strip a wire on opposing sides of the central cutting blade when the handles are depressed so as to remove its outer sheath; and replaceable mating stampers disposed on the side of the stripping blade opposite to the central blade for applying a stamp when the wire and when the handles are compressed, said number stampers being rotatably advanceable with each compression of the handles.

In an even further embodiment, the present invention is a power activated wire cutter, stripper and labeler comprising a housing which encases two matable members when activated; each member comprising mating central cutting blades which cut a wire when the power is activated; mating stripping blades disposed on opposite sides of the cutting blades to strip a wire on opposing sides of the central cutting blade when the power is activated; and mating stampers disposed on the side of the stripping blade opposite to the central blade for applying a stamp when the wire and when the power is activated.

### DESCRIPTION OF THE DRAWINGS

FIG. 1 is a perspective view of the present invention which illustrates the semi-cylindrical housing in an open mode.

FIGS. 2a and 2b illustrate the hand activated system of the present invention in operation.

FIG. 3 is a perspective view of the invention in operation

FIG. 4 is a view of the cable of the present invention after it is cut, stripped and numbered.

FIGS. 5a-6c are perspective views of a powered embodiment of the present invention.

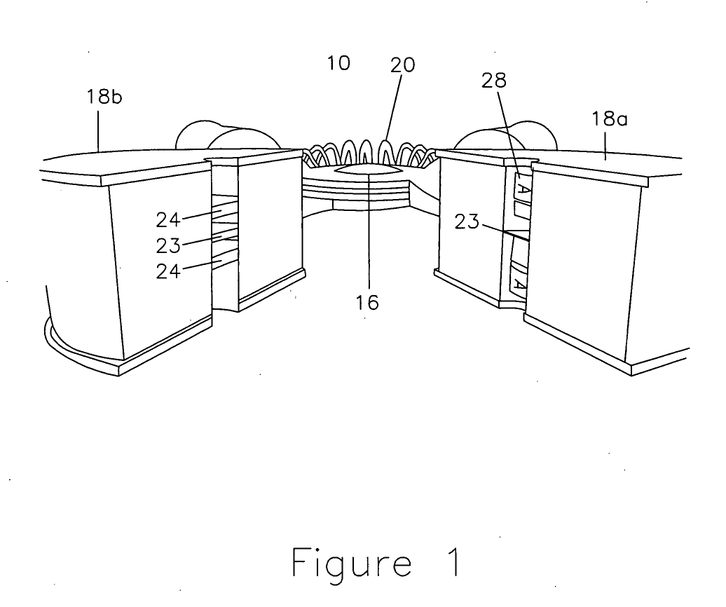

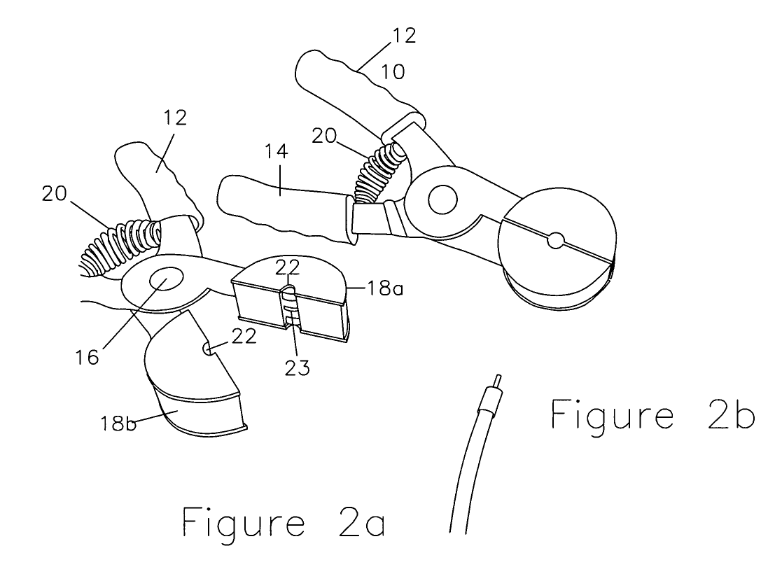

### DETAILED DESCRIPTION OF THE INVENTION

The present invention is described with reference to the enclosed Figures wherein the same numbers are used. The present invention is described in the context of a design which combines three tools when working with electrical wires (one to cut, one to strip, and another to label.) The invention provides a handheld mechanism that cuts, strips and stamps in one simple squeeze. It is designed to provide electricians with one simple tool that performs all of the necessary functions associated with wire preparation that normally necessitates multiple tools and a handyman. In a most preferred embodiment, this invention comprises a hand held device. This device has two handles.

In a preferred embodiment, the invention 10 comprises two handles 12, 14 joined by a pivot point, 16, each terminating in a semi-cylindrical housing 18a, 18b. While the present invention is described in the context of semi-cylindrical housing numbers, it is to be appreciated that the shape of the mating members may take various shapes. The housings 18a, 18b are on opposite sides of the pivot point 16. The handles 12, 14 are biased outward by a spring 20. When the handles 12, 14 are compressed, the semi-cylindrical halves 18a, 18b join together to form a united cylindrical member.

Each of the semi cylindrical members 18a, 18b, has a coaxial bore 22 for a wire. Each of the semi-cylindrical housings support and hold three implements. Each implement is structured within the coaxial bore. These include a central cutting blade 23, dual stripping blades 24 and labeler 28. Each housing member has a central matable blade 23 to cut the wire. The pair of stripping blades 24 are disposed on opposite sides of the central blade. On the other side of the stripping blades 24 are a pair of labelers 28 which label the wire sheath with a letter or number. The labelers 28 may be attached to an advanceable wheel (not shown) which is set up to advance with each activation of the handles.

The tool is approximately the same size as common electrical wire strippers or wire cutters and will easily fit in a toolbox and the hands of any worker. It is to be appreciated that the tool may be produced in a multiplicity of sizes for use on any sized wire. One size is suited for wires including low voltage sizes. A second tool will easily accommodate larger wires.

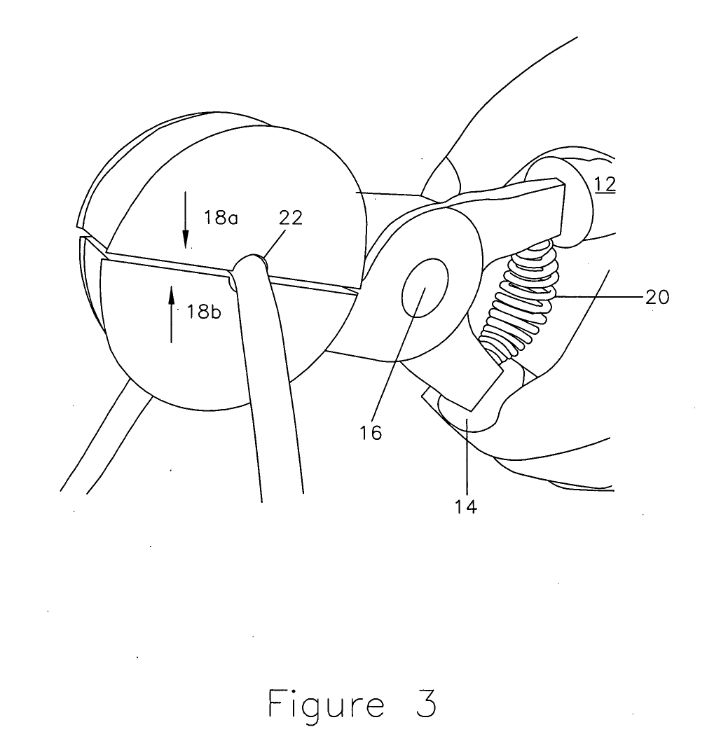

In operation, as shown in FIG. 3, when the handles 12, 14 are depressed, the two housings 18a, 18b, are joined. When the handles 12, 14 are opened, the metal housings are separated to expose the inner blades and labeling mechanisms. Each housing reveals a semi-circular indentation 22 co-axially through the center. This is where the wire will rest prior to being cut, stripped and stamped.

With each use of the system, when one set of letters/numbers are affixed, the labeler mechanism 28 may auto-advance to the next corresponding set of letters or numbers. All of the blades contained within can be replaced when they become dull or if they break.

The spring 20 is located between the two handles to allow the consumer to apply the proper amount of pressure to perform the desired action without becoming fatigued. In use, the wire is placed into the indentation 22 running through the coaxial center of each metal housing.

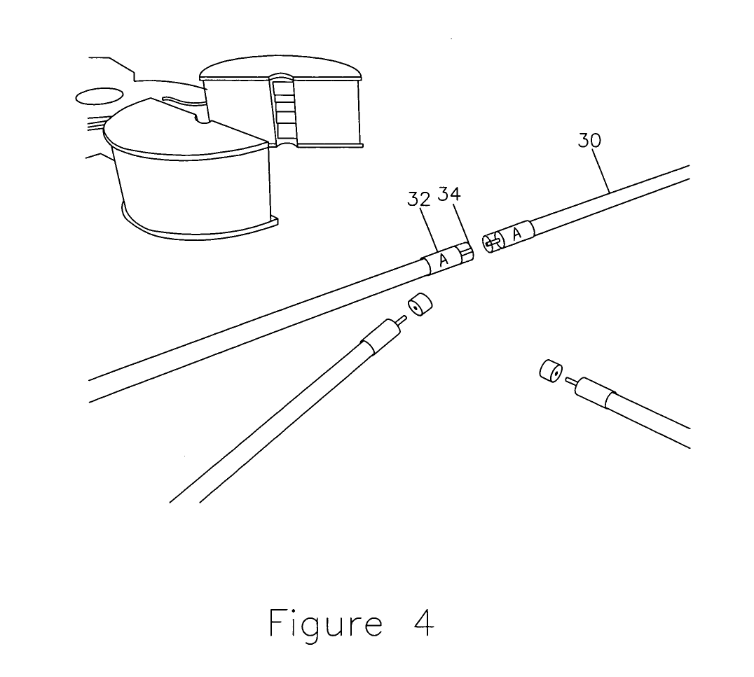

In operation, the handles 12, 14 are depressed, clamping the wire between both metal housings at aperture 22. The handles are then squeezed together, at which time the cutting blade 23 severs the wire; the two stripping blades cut the wire casing (down to, but not including the wire itself); and labeler 28 wraps both remaining pieces of wire in corresponding labels. Hence, when both housings are pressed together, both sides of the wire 30 are cut 34, labeled 32 and stripped in one simple step as shown in FIG. 4.

The present invention includes features which can selectively disable one or more of the implements. For example, the numbering or stripping blades can be disabled. Users may also choose the option of label-only, in which case the cut and stripping blades will be disengaged.

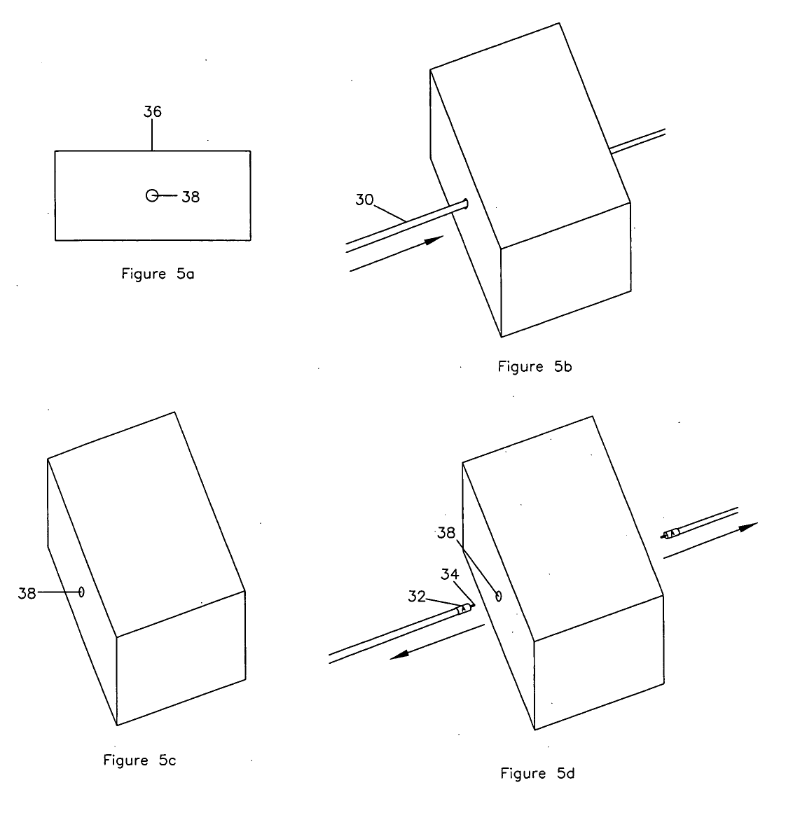

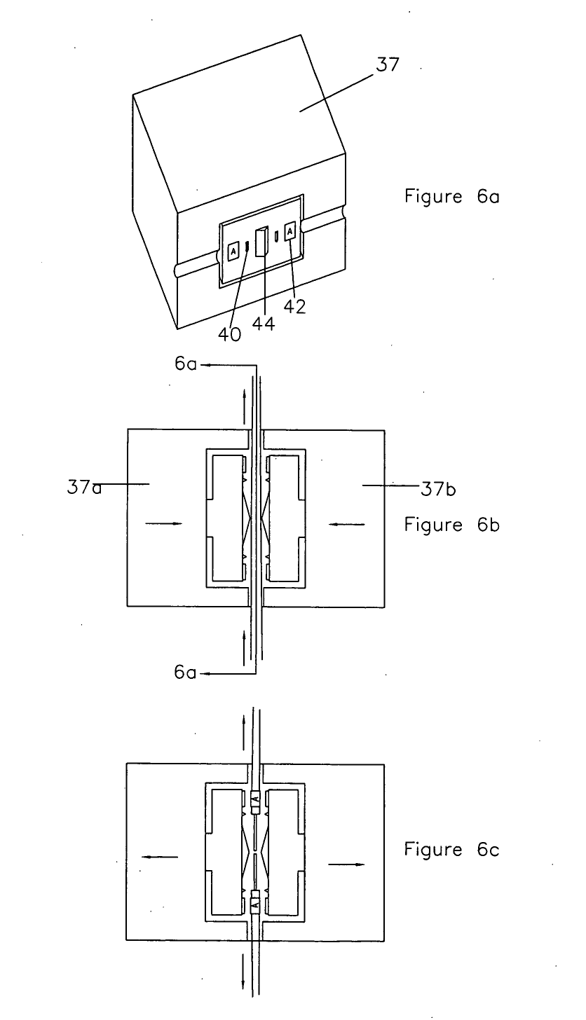

FIGS. 5a to 6c illustrate an automated version of the present invention in this embodiment. In this embodiment, the invention comprises an electronic powered system. This system comprises a housing. The housing has a slot 38 to insert and hold a wire. The interior of the housing has two matable members 37a, 37b which surround the slot and which are power activated to dive together. The members, as in the hand held, each comprise a matable cutting unit 44, pairs of stripping blades 40 on opposite sides of the cutting blades and a pair of labelers 42 on the side of the strippers opposite of the central blade. A power activated system is activated when the members come together so as to cut, strip and label the wire. The power system may employ a multitude of devices such as magnets and screws.

The present invention has been described with reference to the above discussed preferred embodiment. The true nature and scope of the invention is to be determined with reference to the attached claims.

1. A device for cutting, stripping and labeling comprising:
a pair of handles joined at a pivot point, each handle terminating in a housing portion disposed distally from the pivot point, said semi cylindrical housing portions being configured to mate to form a full housing when the handles are compressed;
the interior of each housing further comprising:
mateable central cutting blades which converge to cut a wire when the handles are compressed;
mateable stripping blades disposed on opposite sides of the cutting blades which converge to strip the sheath of a wire when the handles are depressed, so as to remove outer sheath; and
mateable number stampers disposed on the side of the stripping blades opposite to the central blade, for applying a number when the wire and when the handles are compressed.

2. A combination wire cutter, stripper comprising:
a pair of handles joined at a pivot point, each handle terminating in semi cylindrical housing disposed distally from the pivot point, said semi cylindrical housings made to mate to form a cylindrical housing when the handles are compressed;
the interior of the housings further comprising a central aperture to hold a wire;
mating central cutting blades which cut a wire when the handles are compressed;
mating stripping blades disposed on opposite sides of the cutting blades to strip a wire on opposing sides of the central cutting blade when the handles are depressed so as to remove its outer sheath; and
mating number stampers disposed on the side of the stripping blade opposite to the central blade for applying a number when the wire and when the handles are compressed.

3. A combination wire cutter, stripper and labeler comprising:
a pair of handles joined at a pivot point, each handle terminating in semi cylindrical housing disposed distally from the pivot point, said semi cylindrical housings made to mate to form a cylindrical housing when the handles are compressed;
the interior of the housings further having replaceable mating central cutting blades which cut a wire when the handles are compressed;
replaceable mating stripping disposed on opposite sides of the cutting blades to strip a wire on opposing sides of the central cutting blade when the handles are depressed so as to remove its outer sheath; and
replaceable mating stampers disposed on the side of the stripping blade opposite to the central blade for applying a stamp when the wire and when the handles are compressed, said number stampers being rotatably advanceable with each compression of the handles.

4. The combination wire cutter, stripper and labeler of claim 3 which recesses in the stripping blades and stampers and is selectively disengageable.

5. A power activated wire cutter, stripper and labeler comprising:
a housing encasing two matable members when activated;
each member comprising mating central cutting blades which cut a wire when the power is activated;
mating stripping blades disposed on opposite sides of the cutting blades to strip a wire on opposing sides of the central cutting blade when the power is activated; and
mating stampers disposed on the side of the stripping blade opposite to the central blade for applying a stamp when the wire and when the power is activated.
